(19) United States
(12) Patent Application Publication
(10) Pub. No.: US 2024/0421711 A1
(43) Pub. Date: Dec. 19, 2024

(54) CURRENT SHARING OF BIDIRECTIONAL CONVERTERS CONNECTED IN PARALLEL

(71) Applicant: Murata Manufacturing Co., Ltd., Nagaokakyo-shi, Kyoto-fu (JP)

(72) Inventor: Hajime SHIJI, San Jose, CA (US)

(21) Appl. No.: 18/705,016

(22) PCT Filed: Oct. 28, 2022
(86) PCT No.: PCT/US2022/048168

§ 371 Date: Apr. 26, 2024

Related U.S. Application Data
(60) Provisional application No. 63/273,527, filed on Oct. 29, 2021.

(51) Int. Cl. H02M 3/158; H02M 1/00

(52) U.S. Cl. CPC H02M 3/1586; H02M 1/0009; H02M 3/1582

(57) ABSTRACT

A converter system includes a first bidirectional converter electrically connected between a first node and a second node and a second bidirectional converter electrically connected between the first node and the second node in parallel with the first bidirectional converter. Current is shared between the first bidirectional converter and the second bidirectional converter based on a single current-sharing signal.

### BACKGROUND OF THE INVENTION

### 1. Field of the Invention

The present invention relates to electrical converters. More specifically, the present invention relates to bidirectional DC-DC converters.

### 2. Description of the Related Art

When unidirectional DC-DC converters are connected in parallel, it is known to use a current-share bus that connects each of the unidirectional DC-DC converters. A current-sharing signal on the current-share bus represents the average output current of all the unidirectional DC-DC converters. Each unidirectional DC-DC converter attempts to adjust the output current to match the average current.

In known bidirectional DC-DC converter systems that include a plurality of bidirectional DC-DC converters that are connected in parallel, two current sharing signals are necessary, one for each power direction. Due to the bidirectional operation of the bidirectional DC-DC converters, the inputs of each of the bidirectional DC-DC converters when current or power flows in one direction are also outputs of each of the bidirectional DC-DC converters when the current or power flows is the opposite direction. Accordingly, two current-sharing signals are provided for the known bidirectional DC-DC converter systems, with one current sharing signal being provided at each input/output. The two current-sharing signals can be created directly from sensing the current, using a portion of the current at each input/output. For example, current-sensing resistors and current-sensing amplifiers can be used as the current sensing circuits that provide the current-sharing signals. The current-sharing circuits can be bidirectional. Accordingly, known bidirectional DC-DC converter systems that include bidirectional DC-DC converters connected in parallel are required to include two current-sharing buses to share the current-sharing signals at each input/output of the bidirectional DC-DC converters. Isolation between the two current sharing buses is required in isolated bidirectional converters.

### SUMMARY OF THE INVENTION

Preferred embodiments of the present invention provide bidirectional DC-DC converter systems that include bidirectional DC-DC converters connected in parallel that share a single common current-sharing signal, that can include simple features, and that can have low manufacturing costs. A single current-sharing signal can be provided to a plurality of bidirectional DC-DC converters that are connected in parallel. A first bidirectional current-sense circuit is provided at the input/output of each of the bidirectional DC-DC converters, and a second bidirectional current-sense circuit is provided at the output/input of each of the bidirectional DC-DC converters.

A converter system according to a preferred embodiment of the present invention includes a first bidirectional converter electrically connected between a first node and a second node and a second bidirectional converter electrically connected between the first node and the second node in parallel with the first bidirectional converter. Current is shared between the first bidirectional converter and the second bidirectional converter based on a single current-sharing signal.

The first node may provide an input voltage or an output voltage. When the first node provides the input voltage, the second node may provide the output voltage. When the first node provides the output voltage, the second node may provide the input voltage.

Each of the first bidirectional converter and the second bidirectional converter may include a first current-sense circuit connected to the first node and a second current-sense circuit connected to the second node. At least one of the first and second current-sense circuits may include a resistor or a Hall-effect sensor.

The first bidirectional converter may further include a voltage-follower circuit and a controller, and the voltage-follower circuit may be connected to the controller. The controller can output a local current signal to the voltage-follower circuit, and the voltage-follower circuit can receive the local current signal and can output the single current-sharing signal.

The controller can receive the single current-sharing signal, can calculate a pulse width modulation (PWM) duty cycle to set a predetermined output current at the first node or the second node, and can output a PWM signal based on the PWM duty cycle.

The controller can receive the single current-sharing signal, can calculate a pulse frequency modulation (PFM) value to set a predetermined output current at the first node or the second node, and can output a PFM signal based on the PFM value.

The controller can receive the single current-sharing signal, can calculate a phase shift modulation value to set a predetermined output current at the first node or the second node, and can output a phase shift modulation signal based on the phase shift modulation value.

The voltage-follower circuit can include a diode. The voltage-follower circuit can be an amplifier circuit.

Each of the first bidirectional converter and the second bidirectional converter can include a first current-sense circuit and a second current sensing circuit.

The converter system can further include a third bidirectional converter electrically connected between the first node and the second node in parallel with the first and second bidirectional converters, and current can be shared among the first, the second, and the third bidirectional converters based on the single current-sharing signal.

The converter system can further include a system controller that outputs a power-direction signal to the first and the second bidirectional converters. A current value of each output current of the first and the second bidirectional converters can be determined based on the power-direction signal.

The above and other features, elements, steps, configurations, characteristics, and advantages of the present invention will become more apparent from the following detailed description of preferred embodiments of the present invention with reference to the attached drawings.

### BRIEF DESCRIPTION OF THE DRAWINGS

FIG. 1 shows a bidirectional DC-DC converter system including bidirectional DC-DC-converters connected in parallel and including a common current-sharing signal.

FIG. 2 shows two bidirectional DC-DC converters connected in parallel.

FIG. 3 shows a diagram of a microcontroller that controls current sharing that can be used with the bidirectional DC-DC converter system of FIG. 1.

FIGS. 4A to 4D are graphs showing signals associated with the microcontroller shown in FIG. 3.

### DETAILED DESCRIPTION OF PREFERRED EMBODIMENTS

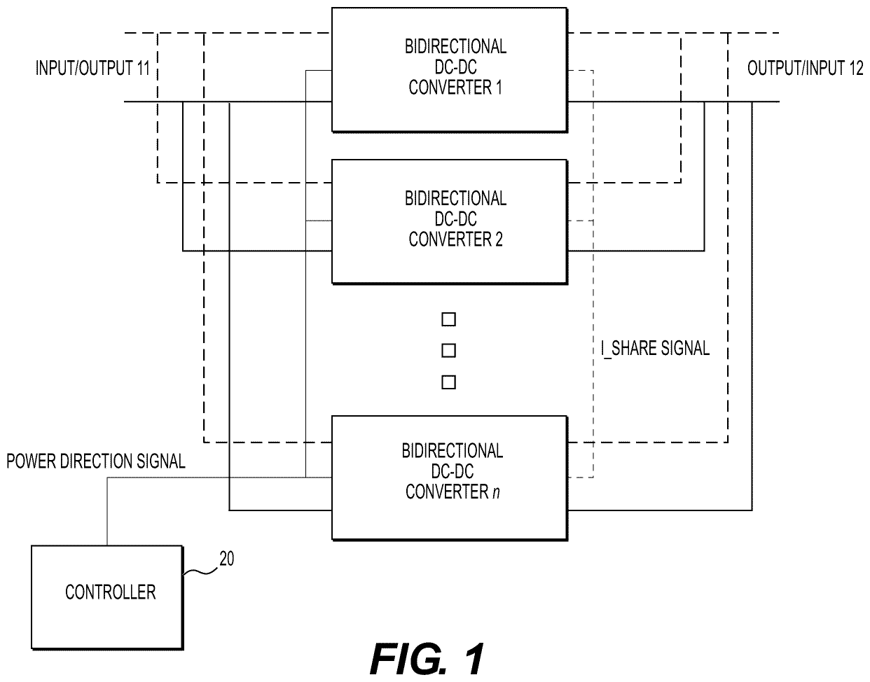

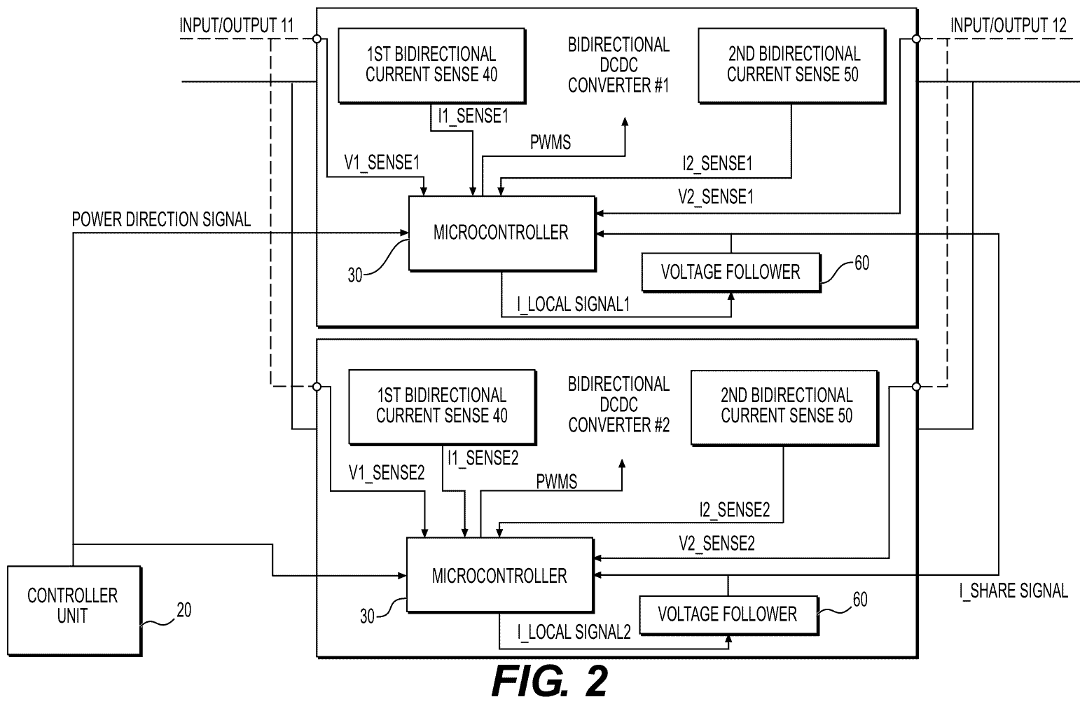

FIG. 1 shows a bidirectional DC-DC converter system 10 with bidirectional DC-DC converters 1, . . . , n connected in parallel. The bidirectional DC-DC converter system shown in FIG. 1 provides parallel operation. FIG. 2 shows a bidirectional DC-DC converter that can be used in the bidirectional DC-DC converter system 10 shown in FIG. 1.

As shown in FIG. 1, the bidirectional DC-DC converter system 10 includes bidirectional DC-DC converters 1, . . . , n, where n can be any integer greater than 1, connected in parallel between a first input/output node 11 and a second output/input node 12. Each of the bidirectional DC-DC converters can include switches or transistors (not shown), including, for example, metal-oxide-semiconductor field-effect transistors (MOSFETs) or other suitable transistors. The switches can be controlled such that the direction of current or power in the bidirectional DC-DC converters can be controlled. Each of the bidirectional DC-DC converters 1, . . . , n, can include the same or substantially the same circuitry.

A single controller 20 can be connected to each of the bidirectional DC-DC converters 1, . . . , n. The controller 20 can be located external to the bidirectional DC-DC converters 1, . . . , n or to the bidirectional DC-DC converter system 10. The controller 20 can provide a power-direction signal to each of the bidirectional DC-DC converters 1, . . . , n to provide redundancy. It is also possible that the current-sharing signal I_SHARE can indicate the direction of power. The bidirectional DC-DC converters 1, . . . , n can be connected to a single common current-sharing signal I_SHARE. The current-sharing signal I_SHARE can be used to set a target value of a DC-DC feedback loop of the bidirectional DC-DC converter system 10. Each of the bidirectional DC-DC converters 1, . . . , n can control its own output voltage and output current according to the current-sharing signal I_SHARE such that each of the bidirectional DC-DC converters 1, . . . , n is controlled to provide an output voltage and output current that matches an overall output voltage and output current provided by the bidirectional DC-DC converter system 10. For example, the output current can be controlled based on the average output current of all of the bidirectional DC-DC converters 1, . . . , n.

It is possible to operate the bidirectional DC-DC converters 1, . . . , n in different configurations. For example, one of the bidirectional DC-DC converters 1, . . . , n can be operated as a master and the remaining bidirectional DC-DC converters 1, . . . , n can be operated as slaves. Alternatively, none of the bidirectional DC-DC converters 1, . . . , n operates as a master converter, such that each of the bidirectional DC-DC converters 1, . . . , n is similarly controlled to maintain redundancy in the bidirectional DC-DC converter system 10. Accordingly, a failure or error in any one of the bidirectional DC-DC converters 1, . . . , n does not cause the overall bidirectional DC-DC converter system 10 to stop operating.

As shown in FIG. 2, a first bidirectional DC-DC converter 1 includes a first bidirectional current-sense circuit 40 that senses the current at the input/output node 11 and a second bidirectional current-sense circuit 50 that senses the current at the output/input node 12. A second bidirectional DC-DC converter 2 can also include a first bidirectional current-sense circuit 40 that senses the current at the input/output node 11 and a second bidirectional current-sense circuit 50 that senses the current at the output/input node 12. The first bidirectional current-sense circuits 40 and the second bidirectional current-sense circuits 50 of the first and the second bidirectional DC-DC converters 1, 2 can include current sensing resistors, bidirectional current amplifiers, Hall-effect sensors, and the like. With first and second bidirectional current-sense circuits 40, 50, the power-direction signal only needs to indicate the direction of current flow.

The first bidirectional current-sense circuits 40 can output an analog signal I1_SENSE that indicates a detected current value and a detected current direction at the input/output node 11, and the second bidirectional current-sense circuits 50 can output an analog signal I2_SENSE that indicates a detected current value and a detected current direction at the output/input node 12. Since the first bidirectional current-sense circuits 40 and the second bidirectional current-sense circuits 50 can output analog signals, values of the signal above a predetermined threshold can indicate current flowing in one direction, whereas values of the signal below the predetermined threshold can indicate current flowing in the opposite direction. However, the first bidirectional current-sense circuits 40 and the second bidirectional current-sense circuits 50 can alternatively provide digital output values to indicate the current direction.

The first bidirectional DC-DC converter 1 and the second bidirectional DC-DC converter 2 shown in FIG. 2 can each also include a microcontroller 30 that can receive (1) the signals I1_SENSE and I2_SENSE from the first and the second bidirectional current-sense circuits 40, 50, (2) the power-direction signal from the controller 20, and (3) the current-sharing signal I_SHARE. The microcontroller 30 can output a current signal I_LOCAL indicating a current value either at the input/output node 11 based on the signal I1_SENSE or at the output/input node 12 based on the signal I2_SENSE. The microcontroller 30 can also output a pulse width modulation (PWM) signal, a pulse frequency modulation (PFM) signal, or a phase shift signal to control power flow by driving the switches of the first and second bidirectional DC-DC converters 1, 2. More specifically, the microcontroller 30 can calculate the pulse width, the pulse frequency, or the phase shift by using a target voltage, a sensed voltage (either the signal V1_SENSE or the signal V2_SENSE), a target current (the current-sharing signal I_SHARE), and a sensed current (either the signal I1_SENSE or the signal I2_SENSE). The microcontroller 30 can select the output current signal, which is either the signal I1_SENSE or the signal I2_SENSE, according to the power-direction signal. If current is flowing from the first input/output node 11 to the second output/input node 12, then the microcontroller 30 selects signal I2_SENSE, and if current is flowing from the second output/input node 12 to the first input/output node 11, then the microcontroller 30 selects signal I1_SENSE. The selected current signal can be amplified by the microcontroller 30 to output the signal I_LOCAL to indicate the value of the output current at either the input/output node 11 or the output/input node 12.

Each of the first bidirectional DC-DC converter 1 and the second bidirectional DC-DC converter 2 shown in FIG. 2 can further include a voltage-follower circuit 60 including a diode, and the voltage-follower circuit 60 sets the current-sharing signal I_SHARE from the signal I_LOCAL. The current-sharing signal I_SHARE is set as a maximum voltage of all of the current sharing signals I_SHARE output from each of the bidirectional DC-DC converters 1, . . . , n (only first and second bidirectional DC-DC converters 1, 2 are shown in FIG. 2). Accordingly, since each of the bidirectional DC-DC converters 1, . . . , n can output a different voltage as the current-sharing signal I_SHARE, the diode and the voltage-follower circuit 60 prevent the signal I_LOCAL from affecting the overall current-sharing signal I_SHARE if the signal I_LOCAL of a particular bidirectional DC-DC converter 1, . . . , n is not set as the maximum overall current-sharing signal I_SHARE. The microcontroller 30 receives the current-sharing signal I_SHARE, which can either be provided from the voltage-follower circuit 60 or from the overall current-sharing signal I_SHARE, and calculates a PWM duty cycle that sets an output current at the first input/output 1 or the second output/input 2 to a value indicated by the current-sharing signal I_SHARE. After calculating the PWM duty cycle, the microcontroller 30 then outputs a PWM signal.

An example of an operation of power flow from the first input/output 1 to the second output/input 2 shown in FIGS. 1 and 2 is described as follows.

First, the microcontroller 30 of each of the first bidirectional DC-DC converter 1 and the second bidirectional DC-DC converter 2 shown in FIG. 2 receives the power-direction signal from the controller 20. The microcontroller 30 of the first bidirectional DC-DC converter 1 then selects either the signal I1_SENSE or the signal I2_SENSE. In this example with the current flowing from the first input/output node 11 to the second output/input node 12, the microcontroller 30 selects the signal I2_SENSE and the direction of current.

Next, the microcontroller 30 outputs the signal I_LOCAL indicating the current value at the output/input node 12, which is defined by the information of the signal I2_SENSE of the second bidirectional current-sense circuit 2 and the direction of current. The voltage-follower circuit 60 sets the current-sharing signal I_SHARE from the current signal I_LOCAL indicating the current value of the output current at the second output/input node 12 of the first bidirectional DC-DC converter 1. The current-sharing signal I_SHARE is shared with other bidirectional DC-DC converter(s) 1, . . . , n that operate in parallel and sets a target value of output current. Upon receiving the current-sharing signal I_SHARE, the microcontroller 30 calculates a PWM duty cycle according to the current-sharing signal I_SHARE.

At least two unidirectional current sensors can be used instead of either the first bidirectional current-sense circuit 40 or the second bidirectional current-sense circuit 50. The unidirectional current sensors can detect output current in each power direction and can be implemented by a simple current sensor.

In addition, command on communication can be used in place of the detected current direction. For example, a command by controller area network (CAN), inter-integrated circuit (I2C), serial peripheral interface (SPI), and the like can be used. That is, instead of providing power direction signals, a communication bus can be used. Accordingly, individual cables to detect current or power direction can be omitted.

The voltage-follower circuit 60 shown in FIG. 2 can be included according to a predetermined voltage capacity of the microcontroller 30 shown in FIG. 2.

Resistors can be included to provide bidirectional current sensing and to provide an improved frequency response. However, to reduce conduction loss, Hall effect sensors can also be included to provide bidirectional current sensing.

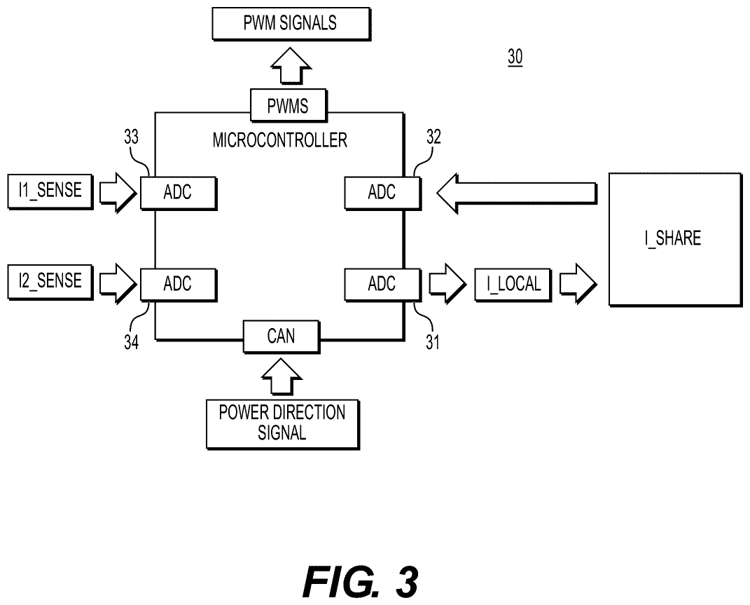

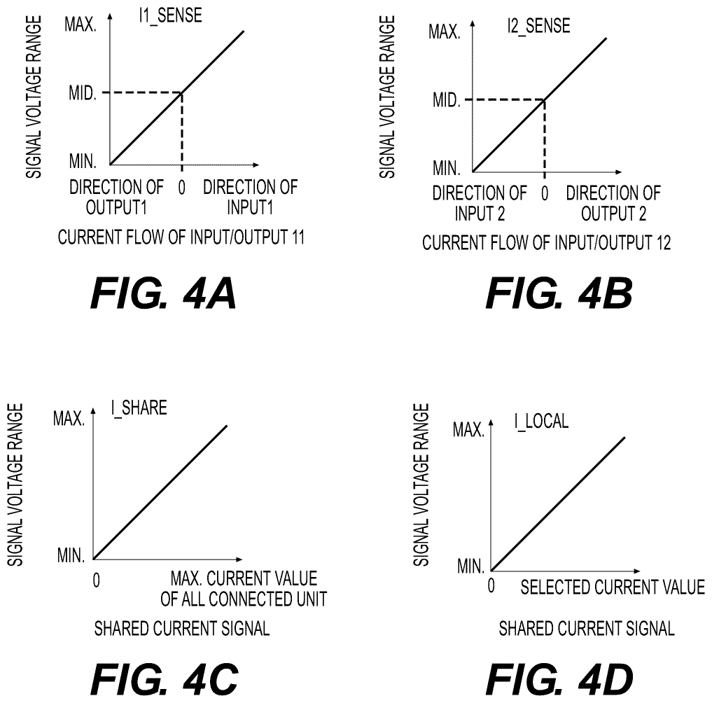

FIG. 3 shows a diagram of a microcontroller 30 that can be used in the bidirectional DC-DC converters 1, . . . , n to control current sharing, and FIGS. 4A to 4D are graphs showing signals associated with the microcontroller 30 shown in FIG. 3.

As shown in FIG. 3, the microcontroller receives the signals I1_SENSE and I2_SENSE from the first and second bidirectional current-sense circuits 40, 50 as shown, for example, in FIG. 2. The signals I1_SENSE and I2_SENSE can be a high-voltage (HV) current signal HV_I_SENSE or a low-voltage (LV) current signal LV_I_SENSE.

The microcontroller 30 shown in FIG. 3 receives a power-direction signal at terminal CAN and selects either the signal I1_SENSE through analog-to-digital converter (ADC) 33 or the signal I2_SENSE through analog-to-digital converter (ADC) 34 according to the power direction indicated by the power-direction signal. The microcontroller 30 can include a digital-to-analog converter (DAC) 31 that outputs the current signal I_LOCAL that indicates a current value at the output, which is either input/output node 11 or output/input node 12. The DAC 31 can output a voltage in a range of about 0 V to about-3.3 V. A voltage follower or amplifier (not shown in FIG. 3) is then applied to the current signal I_LOCAL to provide the current-sharing signal I_SHARE.

The microcontroller 30 shown in FIG. 3 can include an analog-to-digital converter (ADC) 32 that detects the current-sharing signal I_SHARE. The current-sharing signal I_SHARE can be used by the microcontroller 30 to calculate a PWM duty cycle to balance the currents by outputting a PWM signal.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. A converter system comprising:
a first bidirectional converter electrically connected between a first node and a second node; and
a second bidirectional converter electrically connected between the first node and the second node in parallel with the first bidirectional converter, wherein
current is shared between the first bidirectional converter and the second bidirectional converter based on a single current-sharing signal.

2. The converter system according to claim 1, wherein:
the first node provides an input voltage or an output voltage,
when the first node provides the input voltage, the second node provides the output voltage, and
when the first node provides the output voltage, the second node provides the input voltage.

3. The converter system according to claim 1, wherein each of the first bidirectional converter and the second bidirectional converter includes a first current-sense circuit connected to the first node and a second current-sense circuit connected to the second node.

4. The converter system according to claim 3, wherein at least one of the first and second current-sense circuits includes a resistor or a Hall-effect sensor.

5. The converter system according to claim 1, wherein:
the first bidirectional converter further includes a voltage-follower circuit and a controller, and
the voltage-follower circuit is connected to the controller.

6. The converter system according to claim 5, wherein:
the controller outputs a local current signal to the voltage-follower circuit, and
the voltage-follower circuit receives the local current signal and outputs the single current-sharing signal.

7. The converter system according to claim 5, wherein the controller:
receives the single current-sharing signal,
calculates a pulse width modulation (PWM) duty cycle to set a predetermined output current at the first node or the second node, and
outputs a PWM signal based on the PWM duty cycle.

8. The converter system according to claim 5, wherein the controller:
receives the single current-sharing signal,
calculates a pulse frequency modulation (PFM) value to set a predetermined output current at the first node or the second node, and
outputs a PFM signal based on the PFM value.

9. The converter system according to claim 5, wherein the controller:
receives the single current-sharing signal,
calculates a phase shift modulation value to set a predetermined output current at the first node or the second node, and
outputs a phase shift modulation signal based on the phase shift modulation value.

10. The converter system according to claim 5, wherein the voltage-follower circuit includes a diode.

11. The converter system according to claim 5, wherein the voltage-follower circuit includes an amplifier circuit.

12. The converter system according to claim 1, wherein each of the first bidirectional converter and the second bidirectional converter includes a first current-sense circuit and a second current sensing circuit.

13. The converter system according to claim 1, further comprising a third bidirectional converter electrically connected between the first node and the second node in parallel with the first and second bidirectional converters, wherein
current is shared among the first, the second, and the third bidirectional converters based on the single current-sharing signal.

14. The converter system according to claim 1, further comprising a system controller that outputs a power-direction signal to the first and the second bidirectional converters.

15. The converter system according to claim 14, wherein a current value of each output current of the first and the second bidirectional converters is determined based on the power-direction signal.
